(19) United States
(12) Patent Application Publication
(10) Pub. No.: US 2006/0120484 A1
(43) Pub. Date: Jun. 8, 2006

(54) Method to determine optimum receiving device among two dimensional diffusive signal-transmission devices and signal processing apparatus

(75) Inventors: Mitsuhiro Matsumoto, Tokyo (JP); Eiichi Ito, Chiba-ken (JP); Koji Tsuda, Saitama-ken (JP); Masayuki Honjo, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/291,934

(22) Filed: Dec. 2, 2005

(30) Foreign Application Priority Data
Dec. 3, 2004 (JP) 2004-351474

(51) Int. Cl. H04L 27/22

(52) U.S. Cl. 375/316

(57) ABSTRACT

A method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method includes first selecting a first plurality of receiving devices, of which received signal intensities are to be measured, among the plurality of communication devices, first measuring the received signal intensities of the first plurality of receiving devices, first comparing the received signal intensities of the first plurality of receiving devices, second selecting a second plurality of receiving devices based on the results of the first comparing the received signal intensities, second measuring the received signal intensities of the second plurality of receiving devices, second comparing the received signal intensities of the second plurality of receiving devices, and determining the optimum receiving device based on the results of the second comparing the received signal intensities.

### BACKGROUND OF THE INVENTION

The present invention relates to a signal processing apparatus capable of communicating using a two dimensional diffusive signal-transmission technology, and a method to determine an optimum receiving device among two dimensional diffusive signal-transmission devices provided in the signal processing apparatus.

Japanese Unexamined Patent Publication No. 2003-188882 discloses a two dimensional diffusive signal-transmission technology (hereinafter, simply referred to as a 2D-DST technology) for transmitting a signal with a plurality of communication devices (hereinafter, referred to as 2D-DST devices) serving as transmission sites, without forming patterned wiring.

Japanese Unexamined Patent Publication No. 2003-188882 proposes a signal communication apparatus including a plurality of 2D-DST devices scattered on two-dimensional plane therein. Each of the plurality of 2D-DST devices is configured to communicate only with adjacent 2D-DST devices thereto within a predetermined communication distance. By means of such a local communication, a signal is transmitted in sequence from one of the 2D-DST devices to another. This makes it possible to transmit a signal to an intended 2D-DST device. The plurality of 2D-DST devices are categorized into hierarchies based on their predetermined management functions. In each of the hierarchies, a transmission channel data is set such that a signal can be efficiently transmitted to a final destination.

As an application example of the 2D-DST technology, there is cited a system that receives a image signal outputted from an imaging device of a capsule endoscope through wireless communication to transmit the image signal to a predetermined destination using the 2D-DST technology. In the 2D-DST technology, it is desirable to reduce an output of an electromagnetic wave as much as possible in view of electrical power consumption and/or effects on a living body. On the other hand, in order to receive a signal with a high S/N ratio, it is desirable to receive the signal at a position closer to a signal transmitting source. One of solutions to satisfy such requirements, for instance, is to receive a signal with an optimum 2D-DST device being determined. However, as the number of 2D-DST devices increases, a process for determining the optimum 2D-DST device is more complicated, and takes longer time.

### SUMMARY OF THE INVENTION

The present invention is advantageous in that a method to determine an optimum receiving device for receiving a signal through wireless communication while reducing the burden on a control system, in a signal processing apparatus using a 2D-DST technology, is provided.

According to an aspect of the invention, there is provided a method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method including first selecting a first plurality of receiving devices, of which received signal intensities are to be measured, among the plurality of communication devices, first measuring the received signal intensities of the first plurality of receiving devices, first comparing the received signal intensities of the first plurality of receiving devices, second selecting a second plurality of receiving devices based on the results of the first comparing the received signal intensities, second measuring the received signal intensities of the second plurality of receiving devices, second comparing the received signal intensities of the second plurality of receiving devices, and determining the optimum receiving device based on the results of the second comparing the received signal intensities.

Optionally, the selected second plurality of receiving devices may include neighboring communication devices of a receiving device with the highest received signal intensity among the first plurality of receiving devices.

Alternatively or optionally, the second selecting the second plurality of receiving devices may include calculating the ratio of the second highest received signal intensity to the highest received signal intensity among the received signal intensities of the first plurality of receiving devices, and comparing the calculated ratio with a predetermined ratio. Optionally, when the calculated ratio is the predetermined ratio or more, the second plurality of receiving devices may include a receiving device with the highest received signal intensity among the first plurality of receiving devices, neighboring communication devices of the receiving device with the highest received signal intensity, a receiving device with the second highest received signal intensity among the first plurality of receiving devices, and neighboring communication devices of the receiving device with the second highest received signal intensity. Optionally, when the calculated ratio is less than the predetermined ratio, the second plurality of receiving devices may include the receiving device with the highest received signal intensity among the first plurality of receiving devices, and neighboring communication devices of the receiving device with the highest received signal intensity.

Optionally, in the determining the optimum receiving device, a receiving device with the highest received signal intensity among the second plurality of receiving devices may be defined as the optimum receiving device.

Still optionally, the method may further include re-determining a different optimum receiving device when at least one predetermined condition is satisfied after the determining the optimum receiving device.

Optionally, the at least one predetermined condition may include a condition that the received signal intensity of the optimum receiving device is less than a predetermined intensity.

Alternatively or optionally, the at least one predetermined condition may include a condition that a predetermined time period has passed.

Alternatively or optionally, the at least one predetermined condition may include a condition that the absolute time rate of change of the received signal intensity of the optimum receiving device is a predetermined value or more.

Optionally, the re-determining a different optimum receiving device may include third selecting a third plurality of receiving devices, of which received signal intensities are to be measured, among the plurality of communication devices, third measuring the received signal intensities of the third plurality of receiving devices, third comparing the received signal intensities of the third plurality of receiving devices, and re-determining the different optimum receiving device based on the results of the third comparing the received signal intensities.

Yet optionally, the selected third plurality of receiving devices may include neighboring communication devices of the optimum receiving device.

Optionally, the third plurality of receiving devices is selected based on a moving direction, of the external device, presumed from the history of past optimum receiving devices.

According to another aspect of the invention, there is provided a method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method including measuring received signal intensities of all the plurality of communication devices, comparing the received signal intensities of all the plurality of communication devices with each other, and determining the optimum receiving device based on the results of the comparing the received signal intensities.

Optionally, in the determining the optimum receiving device, a communication device with the highest received signal intensity may be defined as the optimum receiving device.

According to a further aspect of the invention, there is provided a method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method including measuring received signal intensities of all the plurality of communication devices, comparing the received signal intensities of all the plurality of communication devices with a predetermined intensity, specifying a region in which communication devices with received signal intensities of the predetermined intensity or more are included, and determining the optimum receiving device among the communication devices in the specified region.

Optionally, in the determining the optimum receiving device, a communication device located substantially at the center of the region may be defined as the optimum receiving device.

Alternatively or optionally, in the determining the optimum receiving device, a communication device located the closest to a control unit, which is configured to implement the method to determine the optimum receiving device, provided at the two dimensional diffusive signal-transmission board, may be defined as the optimum receiving device.

According to a different aspect of the invention, there is provided a signal processing apparatus, which is provided with a two dimensional diffusive signal-transmission board, a plurality of communication devices, two-dimensionally arranged in the two dimensional diffusive signal-transmission board, which are configured to communicate with each other using a two dimensional diffusive signal-transmission technology, and a control unit configured to control the whole of the signal processing apparatus. The signal processing apparatus is configured to implement a method to determine an optimum receiving device, which receives a signal outputted from a separate device through wireless communication, among the plurality of communication devices. The method includes first selecting a first plurality of receiving devices, of which received signal intensities are to be measured, among the plurality of communication devices, first measuring the received signal intensities of the first plurality of receiving devices, first comparing the received signal intensities of the first plurality of receiving devices, second selecting a second plurality of receiving devices based on the results of the first comparing the received signal intensities, second measuring the received signal intensities of the second plurality of receiving devices, second comparing the received signal intensities of the second plurality of receiving devices, and determining the optimum receiving device based on the results of the second comparing the received signal intensities.

Optionally, the selected second plurality of receiving devices may include neighboring communication devices of a receiving device with the highest received signal intensity among the first plurality of receiving devices.

Alternatively or optionally, the second selecting the second plurality of receiving devices may include calculating the ratio of the second highest received signal intensity to the highest received signal intensity among the received signal intensities of the first plurality of receiving devices, and comparing the calculated ratio with a predetermined ratio. Optionally, when the calculated ratio is the predetermined ratio or more, the second plurality of receiving devices may include a receiving device with the highest received signal intensity among the first plurality of receiving devices, neighboring communication devices of the receiving device with the highest received signal intensity, a receiving device with the second highest received signal intensity among the first plurality of receiving devices, and neighboring communication devices of the receiving device with the second highest received signal intensity. Optionally, when the calculated ratio is less than the predetermined ratio, the second plurality of receiving devices may include the receiving device with the highest received signal intensity among the first plurality of receiving devices, and neighboring communication devices of the receiving device with the highest received signal intensity.

Optionally, in the determining the optimum receiving device, a receiving device with the highest received signal intensity among the second plurality of receiving devices may be defined as the optimum receiving device.

### BRIEF DESCRIPTION OF THE ACCOMPANYING DRAWINGS

FIG. 1 schematically shows the configuration of an endoscope system according to the present invention;

FIG. 2 shows the configuration of a capsule endoscope;

FIG. 3 schematically shows a 2D-DST board applied to a jacket provided with an antenna function;

FIG. 4 schematically shows a cross-sectional structure of the 2D-DST board;

FIG. 5 is a drawing illustrating a first method to determine an optimum receiving device according to a first embodiment;

FIG. 6 is a drawing illustrating a second method to determine the optimum receiving device according to the first embodiment;

FIG. 7 is a drawing illustrating a third method to determine the optimum receiving device according to the first embodiment;

FIG. 8 schematically shows the 2D-DST board to illustrate a method to determine the optimum receiving device according to a second embodiment;

FIG. 9 is a flowchart showing a process of the method to determine the optimum receiving device in the second embodiment;

FIG. 10 schematically shows the 2D-DST board to illustrate a method to determine the optimum receiving device according to a third embodiment;

FIG. 11 is a flowchart showing a process of the method to determine the optimum receiving device in the third embodiment;

FIG. 12 schematically shows the 2D-DST board to illustrate a method to determine the optimum receiving device according to a fourth embodiment;

FIG. 13 shows the relationship between the intensity and the S/N ratio of a received signal;

FIGS. 14A, 14B, and 14C show the relationships between time and the received signal intensity to illustrate a first, second, and third conditions for starting a re-determining operation in the fourth embodiment, respectively;

FIG. 15 schematically shows the 2D-DST board to illustrate a method to determine the optimum receiving device according to a fifth embodiment;

FIG. 16 schematically shows the 2D-DST board, which is bended to form a hollow cylinder, to illustrate a method to determine the optimum receiving device according to a sixth embodiment;

FIG. 17 is a cross-sectional view, along a plane parallel to an X-Y plane, of the 2D-DST board to illustrate the method to determine the optimum receiving device according to the sixth embodiment;

FIG. 18 is a cross-sectional view, along a plane parallel to an X-Z plane, of the 2D-DST board to illustrate the method to determine the optimum receiving device according to the sixth embodiment;

FIG. 19 is a flowchart showing a process of the method to determine the optimum receiving device in the sixth embodiment;

FIG. 20 schematically shows a cross-sectional view, along a plane parallel to the X-Y plane, of the 2D-DST board to illustrate a method to determine the optimum receiving device according to a seventh embodiment;

FIG. 21 is a flowchart showing a process of the method to re-determine the optimum receiving device after movement of the capsule endoscope in the seventh embodiment;

FIG. 22 is a cross-sectional view, along a plane parallel to the X-Y plane, of the 2D-DST board to illustrate the method to re-determine the optimum receiving device according to the seventh embodiment; and

FIG. 23 is a cross-sectional view, along a plane parallel to the X-Z plane, of the 2D-DST board to illustrate the method to re-determine the optimum receiving device according to the seventh embodiment.

### DETAILED DESCRIPTION OF THE EMBODIMENTS

A signal communication apparatus and a method to determine an optimum receiving device according to each of embodiments of the present invention is assumed to be applied to clothing provided with an antenna function that receives an image signal outputted from a capsule endoscope. The clothing provided with an antenna function includes circuits incorporated thereon for obtaining information on a physical condition and/or a body cavity image of a patient without using any wired cable or patterned copper film. In addition, the clothing provides better flexibility and durability, and reduces the weight and design limitation thereof, more densely incorporating antennas therein, and obtaining an image signal with a higher S/N ratio. Referring to the accompanying drawings, configurations and operations of endoscope systems, each of which includes such clothing provided with an antenna function, will be explained.

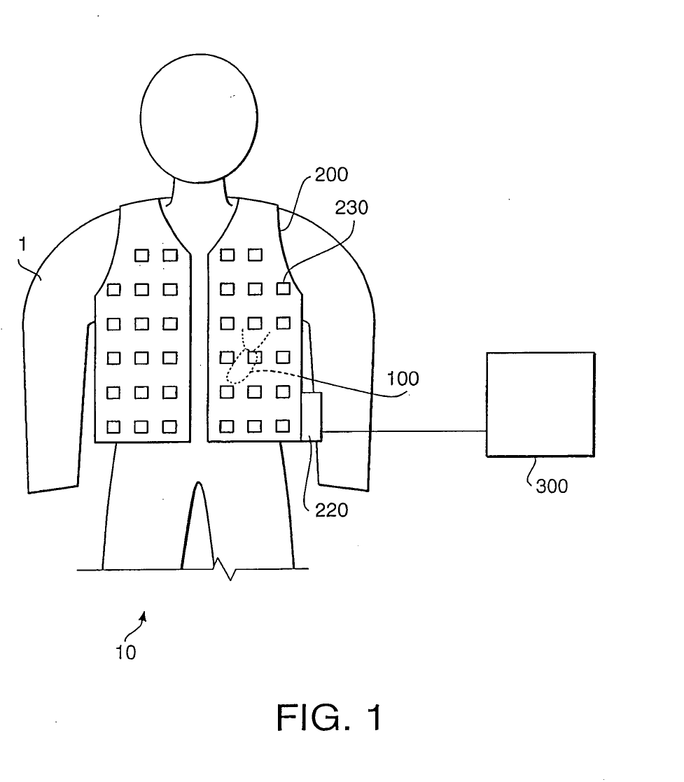

FIG. 1 schematically shows the configuration of an endoscope system 10 according to the present invention. By the endoscope system 10 shown in FIG. 1, information on the physical condition and/or a body cavity image of a patient 1 is acquired, so as to conduct diagnosis on the patient 1. The endoscope system 10 includes a capsule endoscope 100, a jacket 200 (signal communication apparatus) provided with an antenna function, and a PC 300 with a monitor. The capsule endoscope 100 is an inspection device for internal use that is put into the body cavity of the patient 1. The jacket 200 provided with an antenna function, which is wore by the patient 1, is provided with a function to receive image information outputted from the capsule endoscope 100. The PC 300 with the monitor is configured to display the image information obtained by the jacket 200 provided with the antenna function on the monitor.

The jacket 200 with the antenna function, which is shaped so as to cover a part of the body of the patient 1, has a plurality of devices 230 scattered therein. The plurality of devices 230 are 2D-DST devices, each of which includes various functions such as a function to obtain the image signal outputted from the capsule endoscope 100, a function to send out electromagnetic waves for providing an electrical power to the capsule endoscope 100 and/or a control signal, and a function to obtain the information on the physical condition of the patient 1. Hereinafter, such a 2D-DST device is simply referred to as a device. In addition, the jacket 200 includes a control unit 220 attached thereto so as to be located around the waist of the patient 1 while being worn, which controls the whole of the circuits.

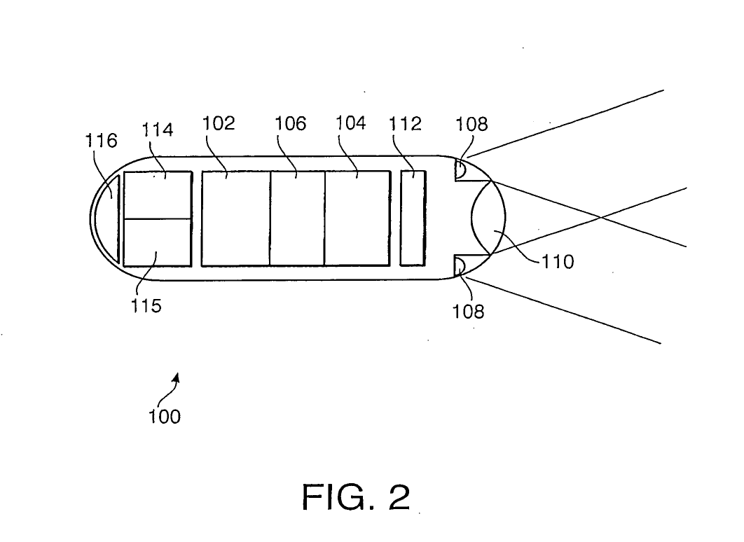

FIG. 2 shows the configuration of the capsule endoscope 100. The capsule endoscope 100 is very small, so as to easily go into an elongated serpentine bowel and take an image of the inside thereof. The capsule endoscope 100 is configured with a power supply portion 102 that supplies electrical power to each of constituents thereof, a controlling portion 104 that controls the whole thereof, a memory 106 that stores various data, two illuminating portions 108 that illuminate the body cavity, an objective optical system 110 for observing the body cavity, a solid-state image sensor 112 that takes an image of the body cavity, a transmitting portion 114 that sends out a radio wave to external devices, a receiving portion 115 that receives a radio wave from external devices, and an antenna portion 116 for sending to and receiving from the external devices.

When the capsule endoscope 100 is put into the body cavity of the patient 1 with the power supply portion 102 being powered on, the body cavity is illuminated by the illuminating portion 108. Illuminating light reflected by a reflecting surface such as a wall of the body cavity is incident to the objective optical system 110, and is received by a light receiving surface of the solid-state image sensor 112 that is provided on a focal plane at the imaging side of the objective optical system 110. The solid-state image sensor 112 photoelectrically-converts the received light to generate an image signal. The controlling portion 104 controls the transmitting portion 114, so that the generated image signal is modulated to be superimposed on a signal with a predetermined frequency, and is then transmitted externally via the antenna portion 116. The transmitted image signal is received by the jacket 200 with the antenna function. In addition, the receiving portion 115 is configured to receive a radio wave from an external device. The controlling portion 104 provides on-off control of the illuminating portion 108 and drive control of the capsule endoscope 100.

Next, the configuration and operation of a 2D-DST circuit incorporated in the jacket 200 with the antenna function will be described.

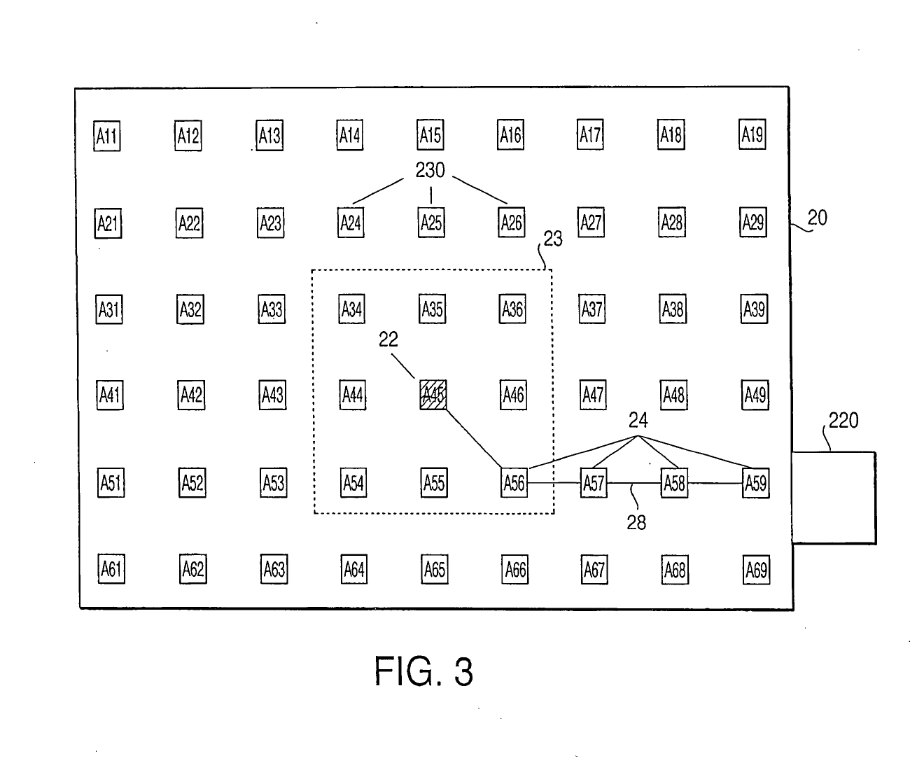

FIG. 3 schematically shows a 2D-DST board 20 applied to the jacket 200 with the antenna function. The 2D-DST board 20 is provided with the plurality of devices 230 and the control unit 220. The device 230 is configured to receive an image signal from the capsule endoscope 100 and transmit the received signal to a predetermined destination (in this case, to the control unit 220). The control unit 220 comprehensively controls the whole of the 2D-DST board 20. In the 2D-DST board 20, one or more optimum device 230 (in an example shown in FIG. 3, a receiving device 22) for receiving an image signal is determined. In this case, all the devices 230 include a receiving means for receiving an image signal such as an antenna. The devices 230 are arranged in a matrix on the 2D-DST board 20. Each of the devices 230 is given its own ID code in sequence from A11 to A69 according to the row and column locations thereof, so as to be identified. The ID code is managed by the control unit 220.

In the aforementioned configuration, for example, when the receiving device 22 receives an image signal outputted from the capsule endoscope 100, the control unit 220 determines transmission devices 24 for transmitting the received signal to the control unit 220 and a transmission channel 28. Based on the determination, the signal received by the receiving device 22 is transmitted to the control unit 220 via the receiving device 22 by means of a predetermined algorithm.

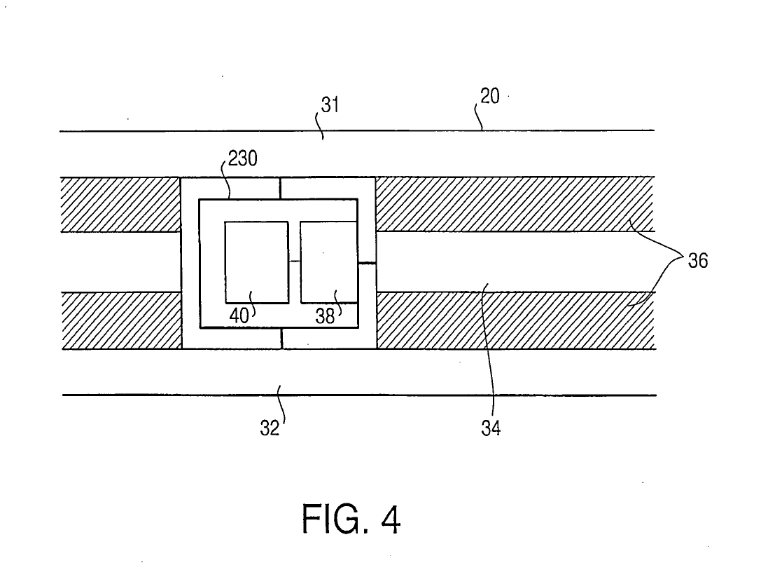

FIG. 4 schematically shows a cross-sectional structure of the 2D-DST board 20. The 2D-DST board 20 is configured using the principle of the communication apparatus disclosed in Japanese Unexamined Patent Publication No. 2003-188882.

The 2D-DST board 20 shown in FIG. 4 is provided with the devices 230, a power supply layer 31 that supplies electrical power to the devices 230, a ground layer 32 for grounding the devices, a signal layer 34 through which a signal is transmitted from one of the devices 230 to another, and insulating layers 36 that electrically isolate the signal layer 34, the power supply layer 31, and the ground layer 32 from each other. Each of the devices 230 includes a communicating part 38 for sending and receiving a signal between itself and any adjacent devices, and a processing part 40 that carries out various kinds of processes in each of the devices 230. In addition, the processing part 40 includes an antenna portion (not shown) configured to receive an image signal outputted from the capsule endoscope 100. It is noted that the configuration of the 2D-DST board 20 shown in FIG. 4 is just one example, and that other configurations may be applicable.

The above configuration is for explaining a first embodiment to seventh embodiment described below. Next, referring to FIG. 3, a method to determine the optimum receiving device applied to a first embodiment according to the present invention will be explained. The method to determine the optimum receiving device is a method to determine the optimum device for receiving a signal transmitted by wireless communication (in this case, an image signal).

As an example of the method to determine the optimum receiving device among the devices A11-A69 capable of receiving an image signal, there is cited a method to determine the optimum receiving device based on results obtained by comparing the intensities of all the devices receiving an image signal with the control unit 220. That is to say, a receiving device receiving an image signal with the highest received signal intensity is defined as the optimum receiving device.

In another example of the method, the optimum receiving device may be determined among receiving devices located within a range in which each of the receiving devices can receive an image signal with predetermined received signal intensity or more. For instance, the receiving devices receiving an image with predetermined received signal intensity or more are assumed to be A34-A36, A44-A46, and A54-A56 in FIG. 3. In this case, an area 23 bounded by a dotted line, as shown in FIG. 3, is defined as a range in which each of the receiving devices can receive the image signal with the predetermined received signal intensity or more. The receiving device A45 located substantially at the center of the area 23 is defined as the optimum receiving device. In a further different example of the method, the receiving device A56, which has the shortest transmission distance to the control unit 220 therefrom in the area 23, may be defined as the optimum receiving device.

Next, the methods to determine the optimum receiving device among the receiving devices in the area 23 defined according to the aforementioned first embodiment will be explained more specifically. The method to determine the optimum receiving device may be the following one.

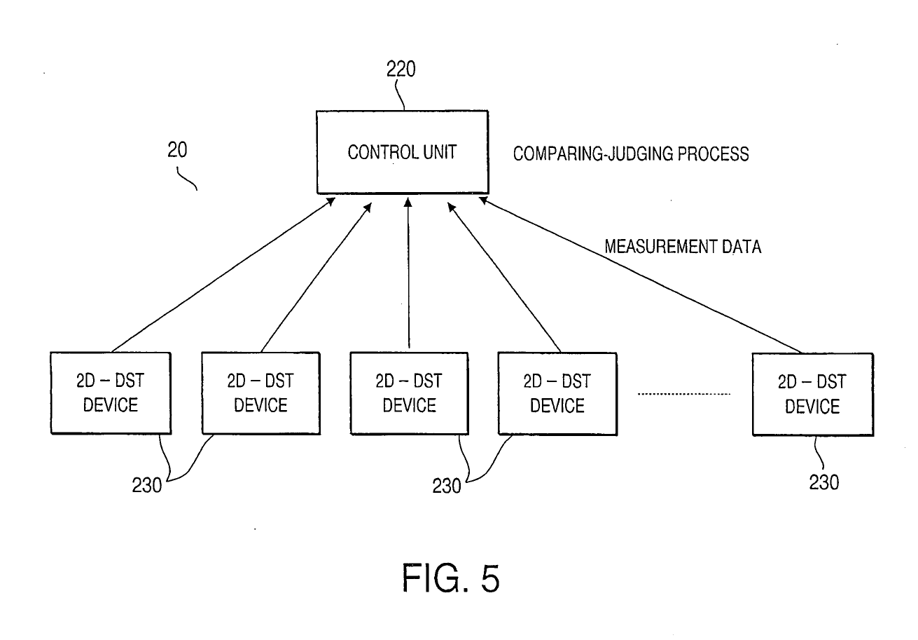

FIG. 5 is a drawing illustrating a first method to determine the optimum receiving device. In the first method, signals, each of which is received by a corresponding one of all the receiving devices (2D-DST devices 230) in a specified area, are transmitted to the control unit 220. Thereafter, the control unit 220 compares all the transmitted signals with each other, for instance, so as to define the receiving device that has received the image signal as the optimum receiving device.

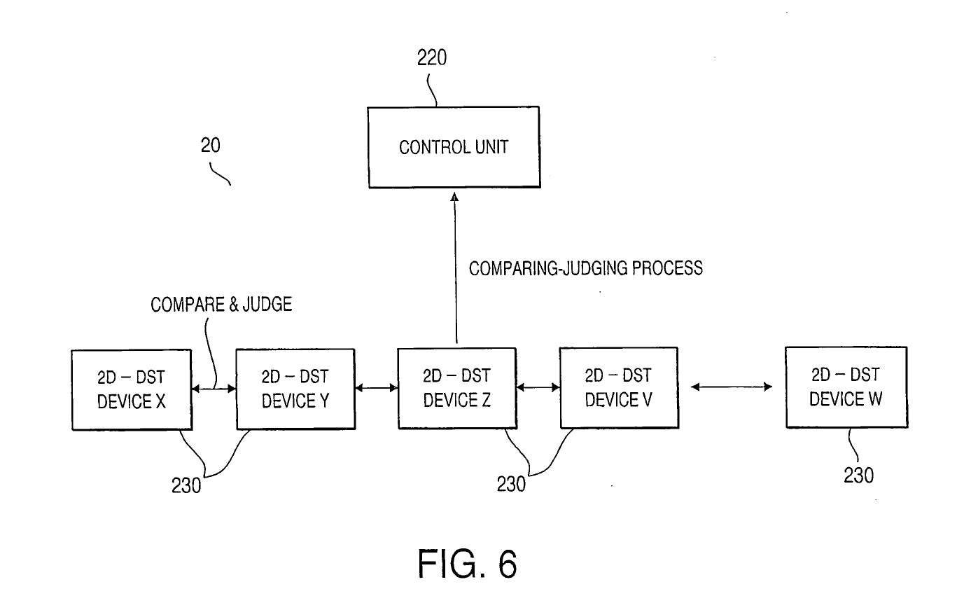

FIG. 6 is a drawing illustrating a second method to determine the optimum receiving device. In the second method, with respect to all the receiving devices (2D-DST devices 230) in a specified area, the comparison between the received signal intensities of any adjacent couple of receiving devices is made. In other words, the comparison between the received signal intensities of each adjacent couple of receiving devices is made, and the comparison result is conveyed, from the receiving devices located at the farthest side end, from the control unit 220, of the 2D-DST board 20 to the closest receiving device to the control unit 220, couple by couple, in order.

Next, referring to FIG. 6, the second method will be explained concretely. On the 2D-DST board 20, there are provided receiving devices V, W, X, Y, and Z. In this case, the receiving device Z is the closest receiving device to the control unit 220. First, a comparison between the received signal intensities of the receiving devices X and Y adjacent to one another is made. It is assumed that as a result of the comparison, the received signal intensity of the receiving device X is judged higher than that of the receiving device Y The receiving device Y stores the ID code and the received signal intensity of the receiving device X. Next, the received signal intensity of the receiving device Z is compared with the received signal intensity of the receiving device X stored in the receiving device Y. When the received signal intensity of the receiving device X is judged higher as a result of the comparison, the ID code and the received signal intensity of the receiving device X is stored in the receiving device Z. The same processes are carried out with respect to all the receiving devices such that a comparison result brought by each of the receiving devices is gathered to the closest receiving device Z to the control unit 220. The receiving device Z makes a final comparison using the gathered comparison results covering all the results of such comparing-judging processes. The receiving device Z, for instance, selects a receiving device with the highest received signal intensity to convey the result of the selection to the control unit 220. It is noted that the aforementioned method can be applied in the case of a larger number of receiving devices.

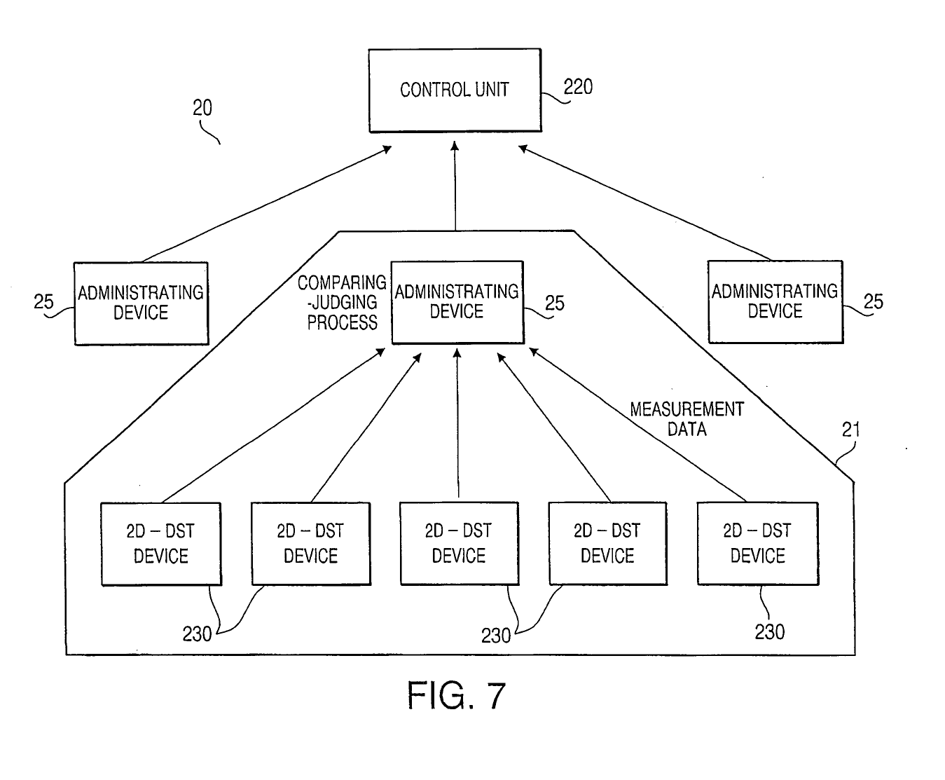

FIG. 7 is a drawing illustrating a third method to determine the optimum receiving device. In this case, the 2D-DST board 20 is provided with the control unit 220, the devices 230 (2D-DST devices), and a plurality of administrating devices that administrate the devices 230. In the third method, the 2D-DST board 20 is divided into a plurality of areas 21. In each of the areas 21, there are arranged a plurality of devices 230. In addition, in each of the areas 21, at least one device 230 is operated as the administrating device 25. It is noted that each of the areas 21 may be divided into some sub-areas. In each of the areas 21, each of all the receiving devices including the administrating device 25 receives a signal. The received signal intensity of each of all the receiving devices is transmitted to the administrating device 25 that is administrating the area 21. The administrating device 25 compares the transmitted received signal intensities. In the same way, such a comparing process is carried out in each of other areas 21. The comparison result is transmitted to the administrating device 25 in a higher-level layer, which carries out the same comparing process. Finally, the comparison result is transmitted to the control unit 220, so that the control unit 220 makes a final comparison to determine the optimum receiving device.

Next, a method to determine the optimum receiving device applied to a second embodiment according to the present invention will be described.

If all the receiving devices carry out measurement of the received signal intensities thereof, the comparing-judging process will be more cumbersome and take more time, as the number of the receiving devices is larger. The following method can simplify the comparing-judging process. First, among all the devices 230 on the 2D-DST board 20, a plurality of receiving devices, which measure the received signal intensities thereof, is selected at a predetermined interval. Thereafter, the receiving device with the highest received signal intensity and the devices around the receiving device with the highest received signal intensity selectively measure their received signal intensities. By the number of the receiving device being thus decreased, an effective comparing-judging process and a reduced necessary time for such a process are achieved.

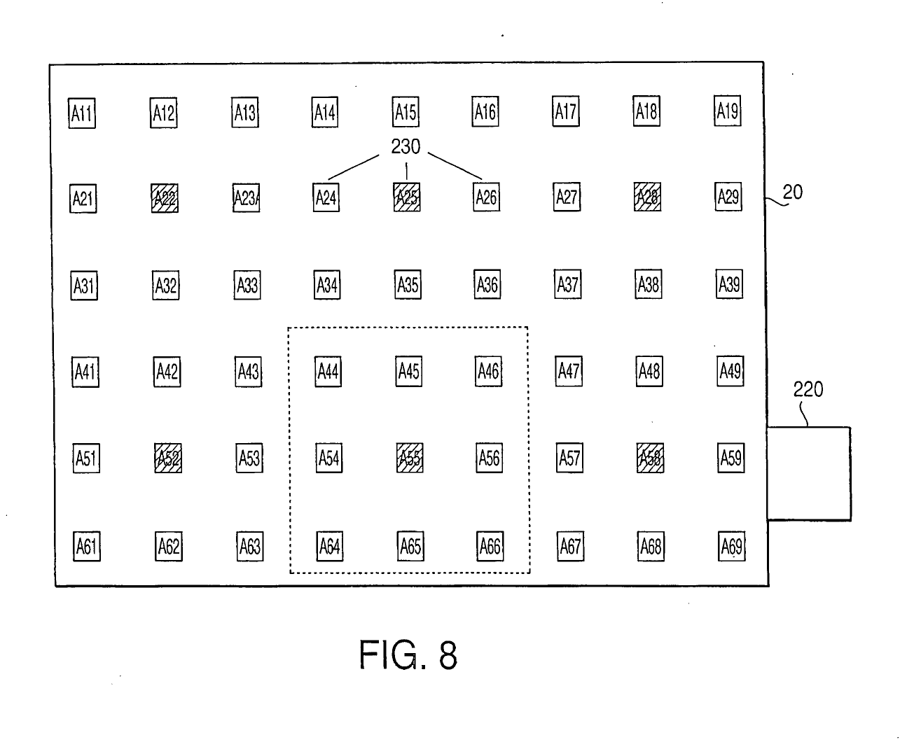

FIG. 8 schematically shows the 2D-DST board 20 to illustrate the method in the second embodiment according to the present invention. The devices 230 are arranged in a matrix on the 2D-DST board 20. The devices 230 are given their own ID codes from A11 to A69 according to their row-column location.

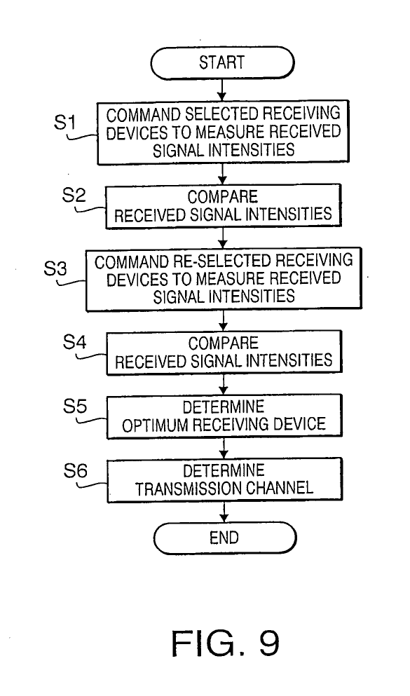

FIG. 9 is a flowchart showing a process of the method to determine the optimum receiving device in the second embodiment according to the present invention. The process shown in FIG. 9 is conducted by the control unit 220.

First, among all the devices 230 on the 2D-DST board 20, a plurality of receiving devices is selected. In this embodiment, for instance, the receiving devices are selected every three devices at even intervals. In this case, the devices A22, A25, A28, A52, A55, and A58 are selected as shown in FIG. 8. It is noted that the receiving devices do not have to be selected at even intervals. For example, the selected receiving devices may be arranged in houndstooth pattern on the 2D-DST board 20. Moreover, the selected receiving devices may be arranged every N (N: positive integer) devices in the vertical (column) direction, every M (M: positive integer) devices in the horizontal (row) direction. In addition, an arrangement of the selected receiving devices with the houndstooth pattern and the pattern of the devices arranged every N devices in the vertical direction every M devices in the horizontal direction being combined may be possible. Various kinds of arrangement patterns of the selected receiving devices may be applicable.

Next, the control unit 220 commands the selected receiving devices A22, A25, A28, A52, A55, and A58 to measure the received signal intensities (S1). When receiving the signal, each of the selected receiving devices measures the received signal intensity thereof. The measurement results by the selected receiving devices are transmitted and gathered to the control unit 220, which then compares the received signal intensities to determine a receiving device with the highest received signal intensity (S2). In this case, for example, the receiving device A55 is identified as a receiving device with the highest received signal intensity.

Thereafter, the devices located around (adjacent to) the receiving device A55 are selected. Then, the control unit 220 commands these selected receiving devices including the receiving device A55 to measure their received signal intensities (S3). According to this command, each of the receiving devices measures the received signal intensity thereof. It is noted that hereinafter, the term “adjacent” includes the meaning of “adjacent in a diagonal direction” or “within a range in which direct communication is possible” (here, the term “direct communication”, for example, means “communication between the first-order devices” or “such communication that the third-order device sends data to a communication device within an effective communication range” described in Japanese Unexamined Patent Publication No. 2003-188882). In this case, the receiving devices A44, A45, A46, A54, A56, A64, A65, and A66 adjacent to the receiving device A55, and the receiving device A55 are selected, as shown in FIG. 8.

The measurement results by the receiving devices are transmitted to the control unit 220, which then compares the received signal intensities (S4), so as to define a receiving device with the highest received signal intensity as the optimum receiving device (S5). In this case, for example, the receiving device A55 is defined as the optimum receiving device. Thereafter, the optimum transmission channel is set between the optimum receiving device and the control unit 220 (S6). The optimum transmission channel is determined such that the transmission channel is the shortest, or such that the number of transmission sites on the transmission channel is the minimum.

It is noted that in the process of S2 for comparing the received signal intensities, the above-mentioned first method is applicable. In addition, in the process of S4 for comparing the received signal intensities, any of the first, second, and third methods is applicable.

Next, a third embodiment, in which a method to determine the optimum receiving device is employed to receive an image signal, will be explained. The method employed in the third embodiment, for example, is applied in the case where the difference between the highest received signal intensity and the second highest one is small in the comparison result in S2 of the flowchart shown in FIG. 9.

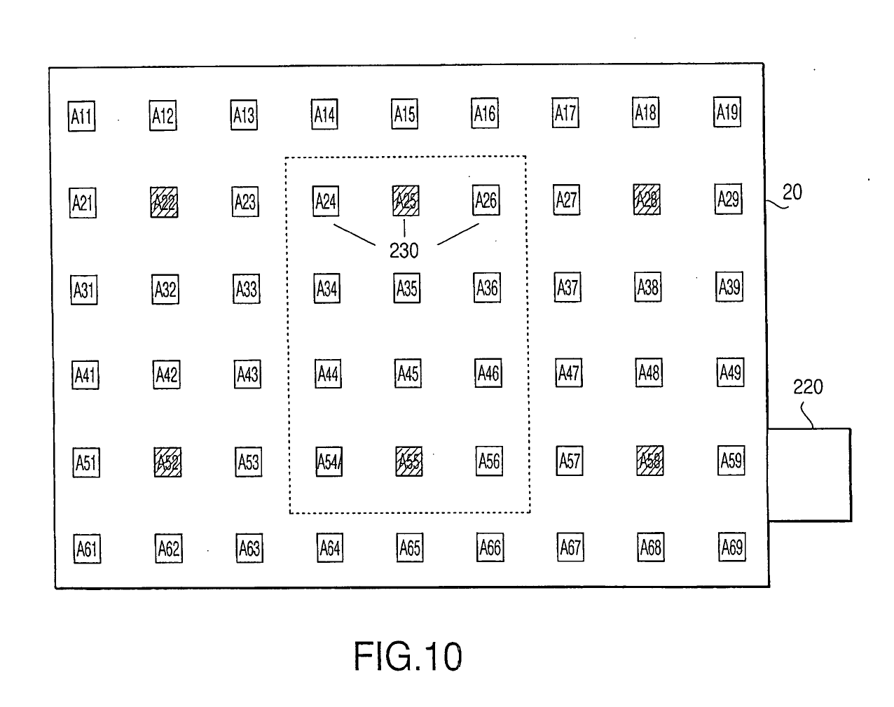

FIG. 10 schematically shows the 2D-DST board 20 to illustrate the method in the third embodiment according to the present invention.

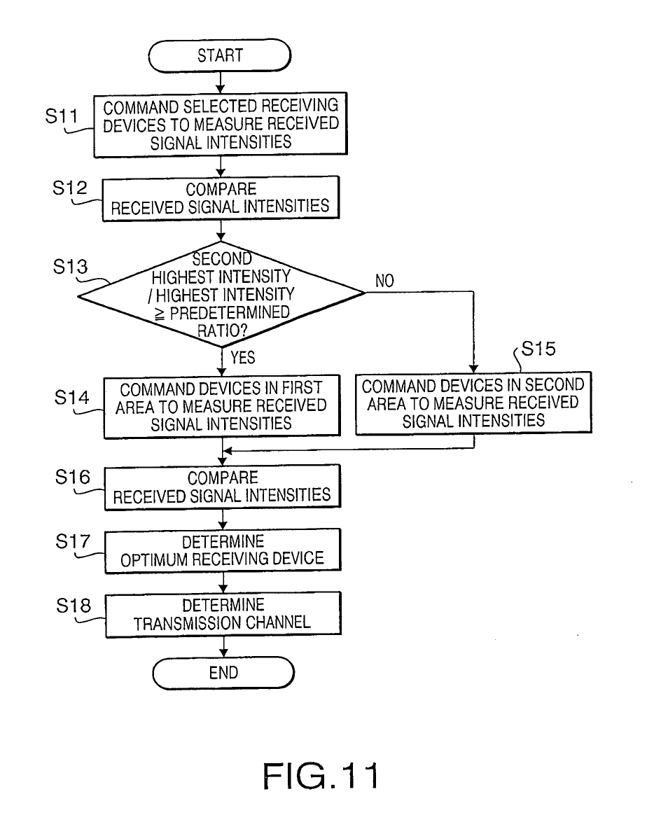

FIG. 11 is a flowchart showing a process of the method to determine the optimum receiving device in the third embodiment according to the present invention. A process of the flowchart shown in FIG. 11 is carried out by the control unit 220.

First, processes S11 and S12, which are the same as S1 and S2 shown in FIG. 9, respectively, are carried out. Next, based upon a comparison result in S12, a ratio of the second highest received signal intensity to the highest received signal intensity is calculated. The calculated ratio is then judged whether it is a predetermined ratio or more (S13). In this case, the receiving device with the highest received signal intensity is A25, and the receiving device with the second highest received signal intensity is A55.

When the calculated ratio is judged to be the predetermined ratio or more in S13 (S13: YES), the control unit 220 commands receiving devices including the aforementioned two receiving devices A25 and A55 in a first area to measure their received signal intensities (S14). In this case, the predetermined ratio, for instance, is 80%, yet any ratio can be set as the predetermined ratio. In the first area, there are included the receiving devices A24, A25, A26, A34, A35, A36, A44, A45, A46, A54, A55, and A56, as shown in FIG. 10.

A method to set the first area will be described below. First, the receiving devices A35 and A45 are selected, which are located on a line connecting the receiving device A25 of the highest received signal intensity with the receiving device A55 of the second highest received signal intensity. Next, the receiving devices A24, A26, A34, A36, A44, A46, A54, and A56 are selected, which are located at both adjacent sides of A25, A35, A45, and A55 in a direction perpendicular to the above line. In this embodiment, an area including these twelve receiving devices is thus set as the first area.

According to the aforementioned command, the above twelve receiving devices measure their received signal intensities to transmit the measurement results to the control unit 220. The control unit 220 compares the received signal intensities (S16) to define a receiving device with the highest received signal intensity as the optimum receiving device (S17). In this case, for example, the receiving device A25 is defined as the optimum receiving device. Thereafter, the optimum transmission channel is set (S18), and the process of the flowchart is terminated.

On the other hand, when the calculated ratio is judged to be less than the predetermined ratio in S13 (S113: NO), the control unit 220 commands receiving devices in a second area to measure their received signal intensities (S15). Thereafter, the process of S16 to S18 is carried out as described above. The second area, in this case, is an area including all the devices adjacent to the receiving device with the highest received signal intensity in the same way as the second embodiment.

It is noted that in the process of S12 for comparing the received signal intensities, the aforementioned first method is applicable. In addition, in the process of S16 for comparing the received signal intensities, any of the first, second, and third methods is applicable.

In the above-mentioned first to third embodiments, the method to determine the optimum receiving device in the case where the location of the optimum receiving device before a re-determining operation is unknown has been explained. In the present invention, the “re-determining operation” represents an operation that is carried out every predetermined timing to re-determine the optimum receiving device. For example, since the optimum receiving device would be shifted from the current one to another, accompanied by reduction of the received signal intensity of the current one and/or movement of the capsule endoscope 100, such a re-determining operation is required.

Next, a method to determine the optimum receiving device, which is employed in a fourth embodiment according to the present invention, will be explained. In the fourth embodiment, a method, which is effective in the case where the location of the optimum receiving device before the re-determining operation is known, is employed, and the capsule endoscope 100 is anticipated to move by short distance for a short time. In the fourth embodiment, the received signal intensities of neighboring devices of the optimum receiving device before the re-determining operation are selectively measured. In the case of a capsule endoscope, when it is passing through esophagus, its velocity is relatively high, yet its velocity is low while moving in other regions. For example, its typical velocity, which depends on the condition in an intestine, though, is 2 cm/min. in a small intestine.

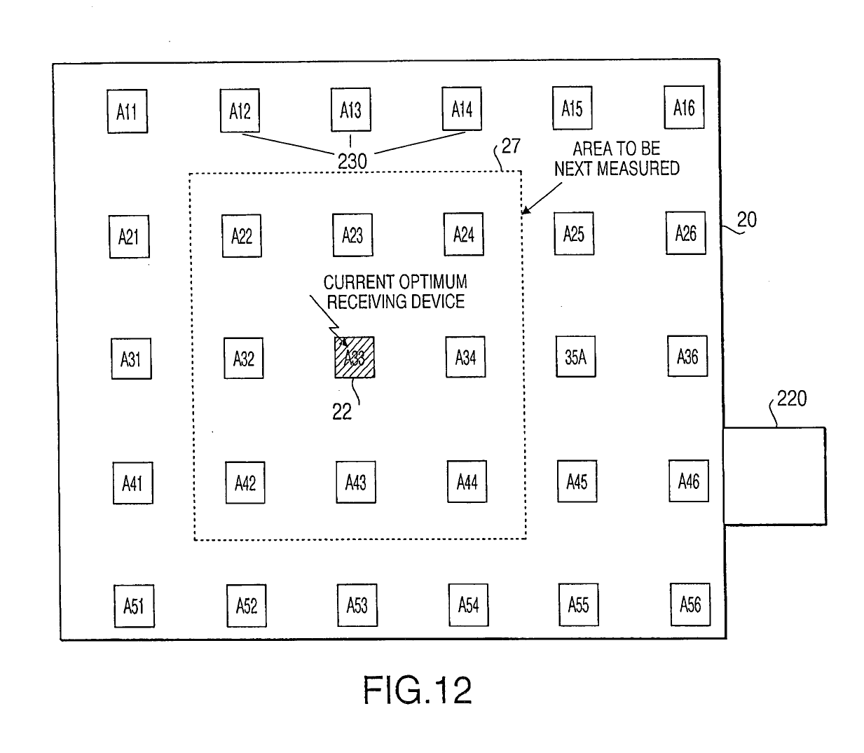

FIG. 12 schematically shows the 2D-DST board 20 to illustrate the method in the fourth embodiment according to the present invention. The devices 230 are arranged in a matrix on the 2D-DST board 20. The devices 230 are given their own ID codes from A11 to A69 according to their row-column location.

By any of the methods in the first to third embodiments, for example, it is assumed that the receiving device A33 is defined as the optimum receiving device, and receives an image signal from the capsule endoscope 100. Since the capsule endoscope 100 is moving, the optimum receiving device after the re-determining operation is anticipated reasonably likely to be any of the receiving device A33 and the receiving devices adjacent thereto A22, A23, A24, A32, A34, A42, A43, A44 in an area 27. The optimum receiving device is determined using any of the aforementioned first to third methods. By selectively measuring the received signal intensities of the receiving devices in the area 27, a process in the re-determining operation can be simplified. The followings can mainly be considered as conditions (timing) for starting the re-determining operation.

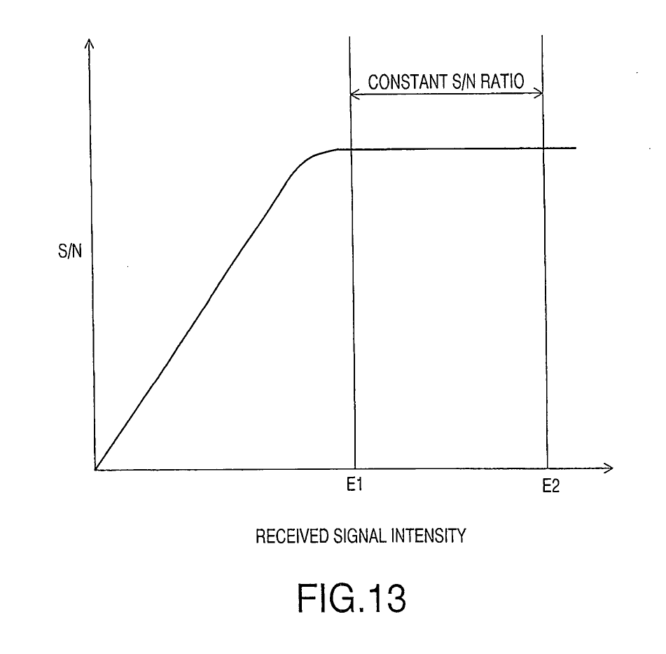

A first condition for starting the redetermining operation (a first starting condition) will be described. FIG. 13 shows the relationship between the intensity (the horizontal axis) and the S/N ratio (the vertical axis) of a received signal. As shown in FIG. 13, as the received signal intensity increases, the S/N ratio of the received signal increases. When the received signal intensity is more than an intensity of E1, the S/N ratio is constant. Since a high S/N ratio is required to improve the certainty of communication, the received signal intensity more than a predetermined level is necessary.

Accordingly, even though the redetermining operation is not frequently carried out, while the optimum receiving device once determined keeps the received signal intensity thereof more than the predetermined level, the optimum receiving device and the transmission channel can be continuously used. The redetermining operation is carried out only in the case where the received signal intensity becomes less than the predetermined level, and thereby the S/N ratio is reduced, so that the optimum receiving device and the transmission channel are re-determined.

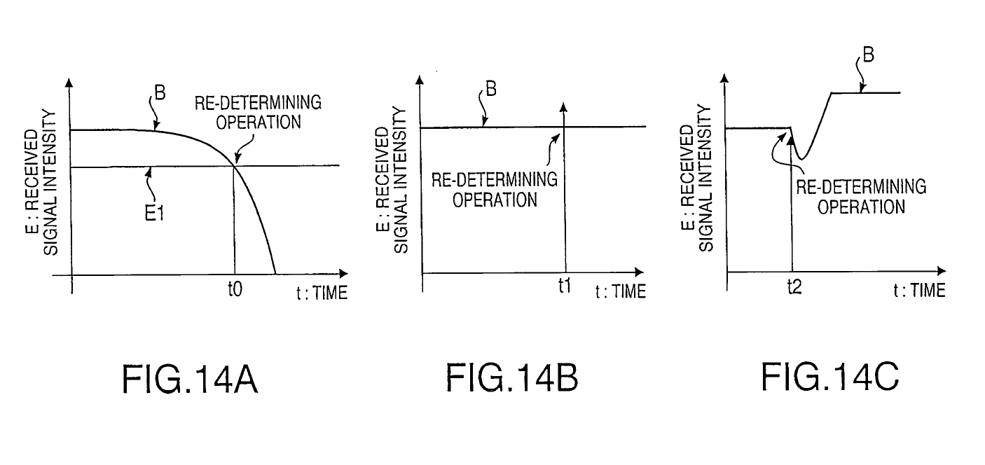

FIG. 14A shows the relationship between time (the horizontal axis) and the received signal intensity (the vertical axis) to illustrate the first starting condition. As aforementioned, the S/N ratio is determined by detecting the received signal intensity. In the case of the first starting condition being employed, the re-determining operation is carried out at a time when the received signal intensity B has become less than a predetermined level E1 (at a time of t0 in FIG. 14A).

Next, a second starting condition will be described. FIG. 14B shows the relationship between time (the horizontal axis) and the received signal intensity (the vertical axis) to illustrate the second starting condition. In the case of the second starting condition being employed, the re-determining operation is carried out at a time when a predetermined time of t1 has passed after the previous re-determining operation being carried out.

A third starting condition will be described. FIG. 14C shows the relationship between time (the horizontal axis) and the received signal intensity (the vertical axis) to illustrate the third starting condition. In the case of the third starting condition being employed, the changing rate of the received signal intensity is monitored, and the re-determining operation is carried out at a time when the received signal intensity has changed at a predetermined rate or more (at a time of t2 in FIG. 14C). More specifically, the re-determining operation is carried out at a time when an absolute value obtained by differentiating the received signal intensity with respect to time has become a predetermined level or more.

Next, a method to determine the optimum receiving device, which is employed in a fifth embodiment according to the present invention, will be explained. In the fifth embodiment, a method, which is effective when a plurality of locations of the successive optimum receiving devices before the re-determining operation is known, is employed, and thereby, the moving direction of the capsule endoscope 100 is presumable. In the fifth embodiment, the received signal intensities of receiving devices located around a presumed moving direction of the optimum receiving device are selectively measured.

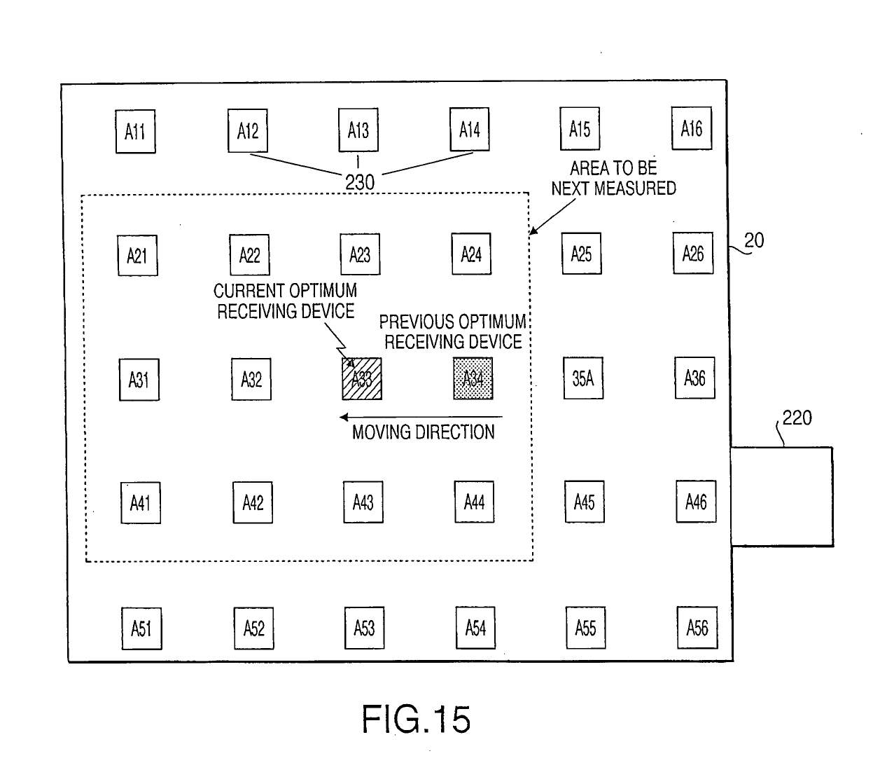

FIG. 15 schematically shows the 2D-DST board 20 to illustrate the method in the fifth embodiment according to the present invention. The devices 230 are arranged in a matrix on the 2D-DST board 20. The devices 230 are given their own ID codes from A11 to A69 according to their row-column location.

It is assumed that the receiving device A33 is the closest to the signal source (the capsule endoscope 100), and receives an image signal. In other words, the receiving device A33 is the current optimum receiving device in this case. In addition, it is assumed that the optimum receiving device before the last re-determining operation (the previous optimum receiving device) is the receiving device A34. The moving direction of the capsule endoscope 100 can be presumed by monitoring the successive optimum receiving devices through time. In this case, the capsule endoscope 100 is presumed to move in a direction going from the previous optimum receiving device A34 to the current optimum receiving device A33. Based on such a presumption, the capsule endoscope 100, for instance, is anticipated reasonably likely to move to a neighboring part around an extension of the moving direction, in addition to the circumference of the receiving device A33, at a time of the next re-determining operation. By selectively measuring the received signal intensities of receiving devices located in an area to which the capsule endoscope 100 is anticipated to move at a time of the next re-determining operation, a process carried out in the re-determining operation can be simplified.

Here, a method to select receiving devices located around an area to which the capsule endoscope 100 is anticipated to move will be explained. First, receiving devices A31 and A32 are selected, which are an extension of a line extending from the receiving device A34 to the receiving device A33. Next, the receiving devices A21, A22, A23, A24, A41, A42, A43, and A44 are selected, which are located at both adjacent sides of the receiving devices A31, A32, A33, and A34 in a direction perpendicular to the aforementioned line.

As mentioned above, after setting an area to which the capsule endoscope 100 is anticipated to move, the optimum receiving device is determined using any of the aforementioned first, second, and third methods. In addition, the re-determining operation is carried out under any of the above first, second, and third starting conditions.

Hereinbefore, the embodiments in which the devices 230 are arranged on a two-dimensional plane have been explained. However, in order to receive a signal outputted from the capsule endoscope 100 inside a patient, it is necessary to take into consideration the not two-dimensional but three-dimensional positional relationship between the capsule endoscope 100 and the devices 230.

A method to determine the optimum receiving device, employed in a sixth embodiment according to the present invention, will be explained. In the sixth embodiment, the devices 230 are two-dimensionally arranged on the 2D-DST board 20, yet the 2D-DST board 20 is bent to form a three-dimensional shape.

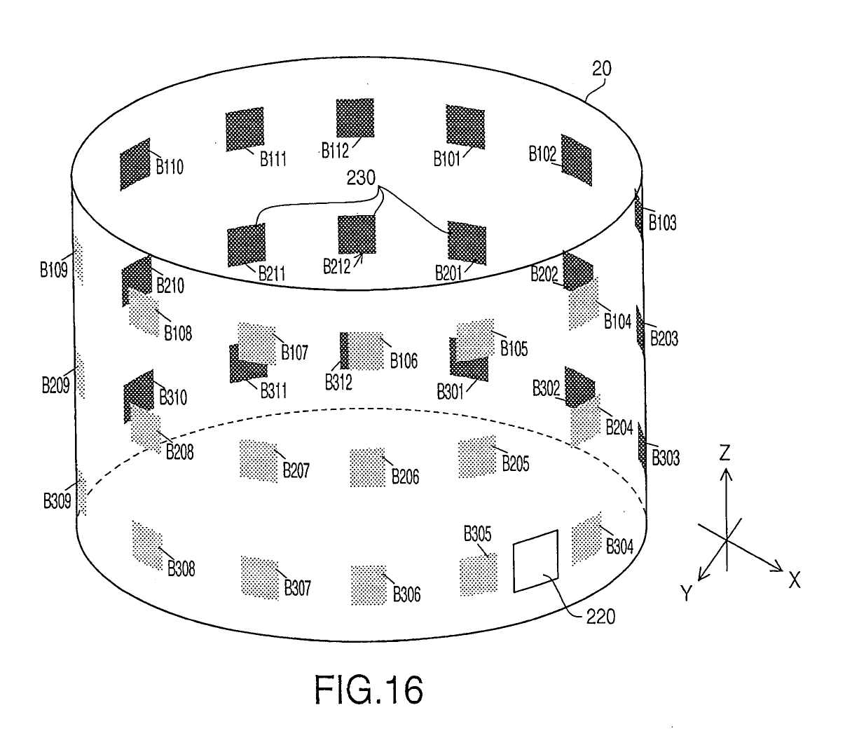

FIG. 16 schematically shows the 2D-DST board 20 to illustrate the method in the sixth embodiment. The 2D-DST board 20 is provided with the devices 230 and the control unit 220, and is assumed to be worn by a human being as a belt. The rectangle 2D-DST board 20 is bent, and the both side ends thereof are joined. Thereby, the 2D-DST board 20 forms a three-dimensional shape of a hollow cylinder.

In the 2D-DST board 20 shown in FIG. 16, the devices 230 are arranged in three rows. In a first row, which is the highest in a (below-mentioned) Z axis direction, there are arranged receiving devices B101-B112. In a second row, which is the middle row in the Z axis direction, there are arranged receiving devices B201-B212. In a third row, which is the lowest in the Z axis direction, there are arranged receiving devices B301-B312. These receiving devices are arranged substantially at even intervals in each of the rows. Here, a line extending from the receiving device B310 to the receiving device B304 is defined as an X axis. A line extending from the receiving device B301 to B307 is defined as an Y axis. In addition, an axis, which intersects the intersection (origin) of the X axis and the Y axis and is perpendicular to both of the X and Y axes, is defined as the Z axis. It is noted that the devices 230 may be arranged in more than three rows.

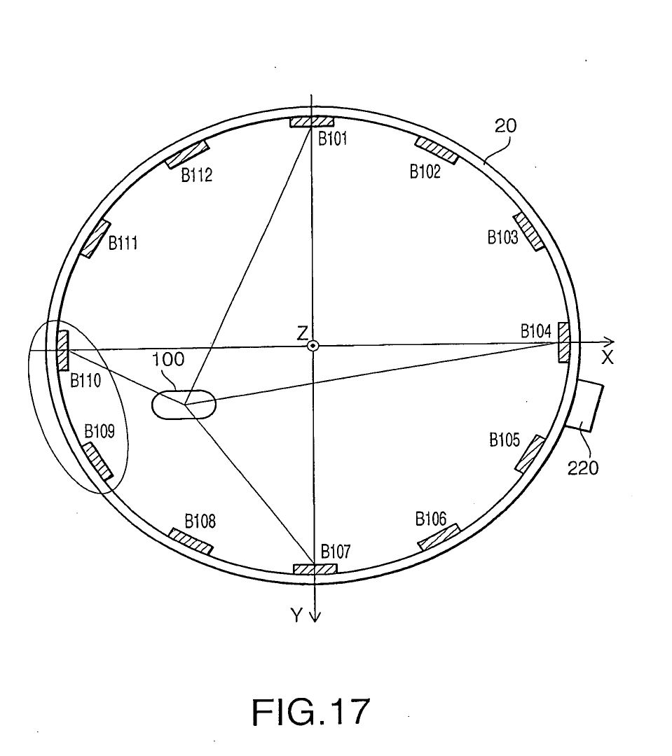

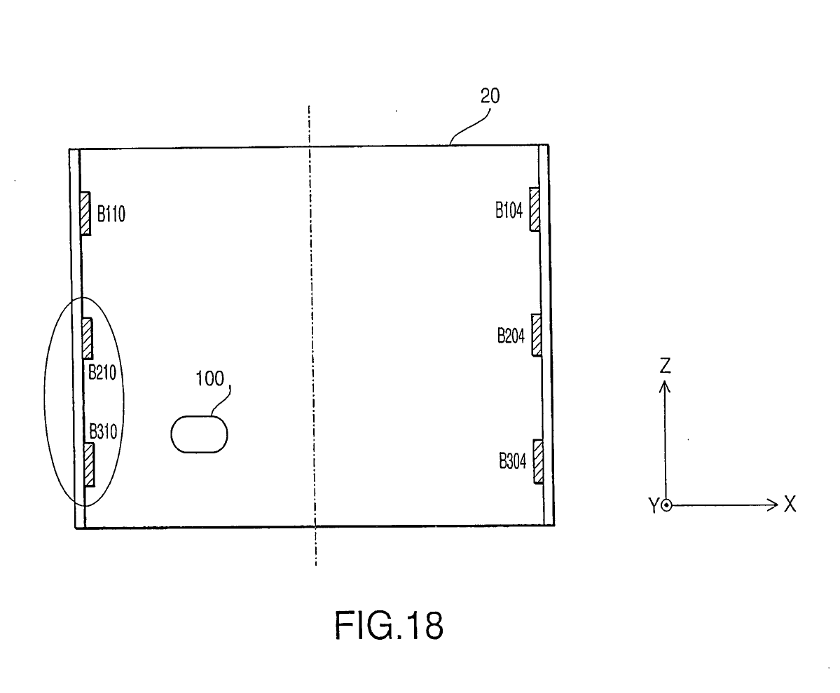

FIG. 17 is a cross-sectional view, along a plane parallel to the X-Y plane, of the 2D-DST board 20 to illustrate the method in the sixth embodiment. FIG. 18 is a cross-sectional view, along the X-Z plane, of the 2D-DST board 20. The capsule endoscope 100 is positioned inside the hollow cylinder-shaped 2D-DST board 20 in the sixth embodiment.

Hereinafter, a concrete method to determine the optimum receiving device in the sixth embodiment will be explained. First, a plurality of receiving devices are selected, with a predetermined distance being spaced, among all the devices on the 2D-DST board 20, and the received signal intensities thereof are measured. Some receiving devices in the first row and some receiving devices, at the same location as the above receiving devices in the X-Y coordinates, in the third row are selected. For example, a receiving device B101 in the first row is selected. Next, a receiving device 107, which faces the receiving device B101 across the Z axis, is selected. In addition, receiving devices B104 and B110, which are located on a line perpendicular to the Z axis and a line extending from the receiving device B101 to the receiving device B107, are selected. Further, receiving devices, in the third row, at the same location as the above four receiving devices in the X-Y coordinates, are selected. In this case, receiving devices B301, B304, B307, and B310 are selected. The receiving devices are thus selected to search the position of the capsule endoscope 100.

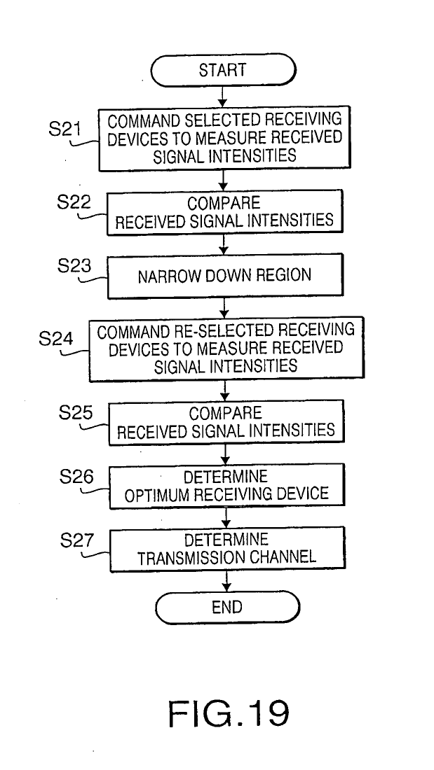

Hereinafter, referring to FIG. 19, a process for determining the optimum receiving device will be explained. FIG. 19 is a flowchart showing a process of the method to determine the optimum receiving device in the sixth embodiment according to the present invention. The process shown in the flowchart in FIG. 19 is carried out by the control unit 220.

First, the control unit 220 commands the receiving devices B101, B104, B107, B110, B301, B304, B307, and B310, selected in the aforementioned way, to measure their received signal intensities (S21). According to this command, each of the receiving devices measures the received signal intensity thereof to transmit the measurement result to the control unit 220.

The control unit 220 compares the received signal intensities (S22), and narrows down a region in which the capsule endoscope 100 is likely to be in the following way (S23). First, the control unit 220 adds the received signal intensity of each of the receiving devices in the first row to the received signal intensity of a corresponding one of the receiving devices in the third row. In particular, a sum B01 of the received signal intensities of the receiving devices B101 and B301, a sum B04 of the received signal intensities of the receiving devices B104 and B304, a sum B07 of the received signal intensities of the receiving devices B107 and B307, and a sum B110 of the received signal intensities of the receiving devices B110 and B310 are calculated.

Thereafter, the control unit 220 selects the largest value and the second largest value among the sums B01, B04, B07, and B130, and narrows down the region, in which the capsule endoscope 100 is likely to be, based on the largest value and the second largest value. For example, it is assumed that the largest value is the sum B10, and the second largest value is the sum B07. In this case, the region, in which the capsule endoscope 100 is likely to be, is limited in the third quadrant of the X-Y plane.

In addition, since the sum B10 is larger than the sum B07, the region in which the capsule endoscope 100 is likely to be can be narrowed to a neighboring region of the receiving devices B310, B210, B310, B109, B209, and B309.

Furthermore, the control unit 220 compares the receiving devices B110 and B310. Thereby, the location of the capsule endoscope 100 can be narrowed to the side of the first row or the side of the third row. For example, in this case, the received signal intensity of the receiving device B310 is higher than that of the receiving device B110. Therefore, the capsule endoscope 100 can be presumed to be located closer to the third row as shown in FIG. 18. Based on such presumption, the location of the capsule endoscope 100 can finally be narrowed to a neighboring region of the receiving devices B210, B310, B209, and B309.

After the aforementioned process for narrowing down the location of the capsule endoscope 100, the control unit 220 commands the receiving devices B210, B310, B209, and B309 to measure their received signal intensities (S24). According to such a command, each of the receiving devices measures the received signal intensity thereof, and the measurement result is transmitted to the control unit 220. Then, the control unit 220 compares the received signal intensity with any other received signal intensities (S25), and a receiving device with the highest received signal intensity is defined as the optimum receiving device (S26). For example, in this case, the closest receiving devices to the capsule endoscope 100 in the X-Y plane are the receiving devices B109, B209, and B309, as shown in FIG. 17, the closest receiving device to the capsule endoscope 100 in the Z axis is in the third row, as shown in FIG. 18. Accordingly, the receiving device B309 is judged to be a receiving device with the highest received signal intensity, and is defined as the optimum receiving device. Thereafter, the optimum transmission channel is determined (S27), and the process of the flowchart is then terminated.

In the 2D-DST board 20 with the three-dimensional structure in the sixth embodiment, the first optimum receiving device has been selected. A method, which is carried out based upon the first optimum receiving device in the next re-determining operation, of determining the optimum receiving device in a seventh embodiment, will be explained.

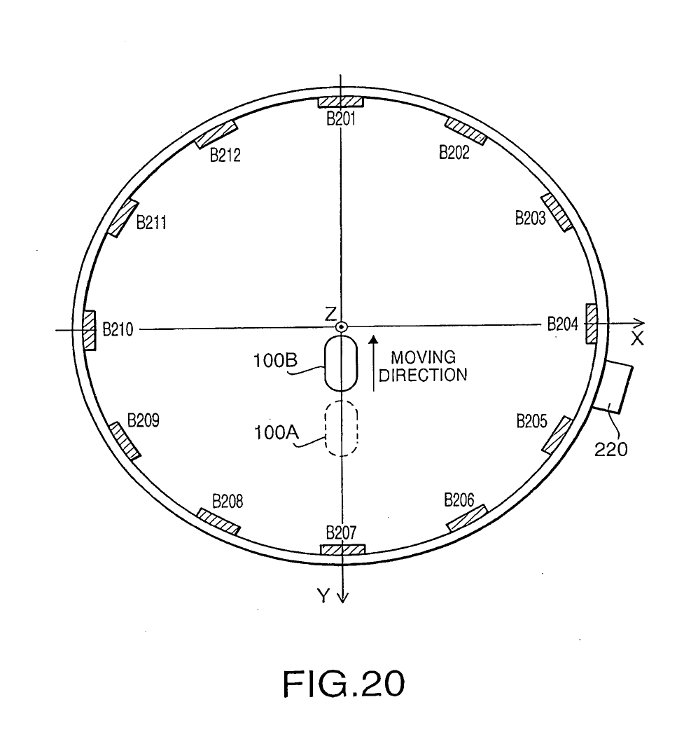

FIG. 20, which is similar to FIG. 17, is a cross-sectional view, along a plane parallel to the X-Y plane, of the 2D-DST board 20 to illustrate the method in the seventh embodiment. FIG. 20 schematically shows the capsule endoscope 100 moving to the center of the substantially cylinder-shaped 2D-DST board 20. Inside the 2D-DST board 20 in the seventh embodiment, there are shown a capsule endoscope 100A before moving and a capsule endoscope 100B after moving. Referring to the locations of the capsule endoscopes 100A and 100B, the capsule endoscope 100, at first, is located the closest to the receiving device B207. Next, the capsule endoscope 100 moves along the Y axis from the first location. In this case, it is assumed that the receiving device B207 has been defined as the optimum receiving device in the previous process of determining the optimum receiving device.

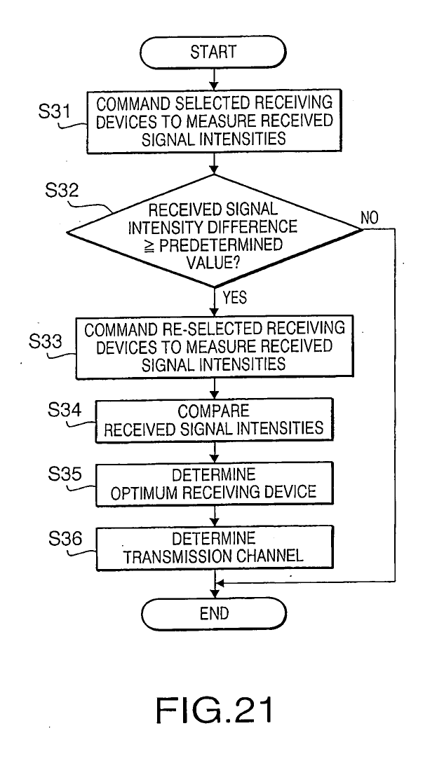

FIG. 21 is a flowchart showing a process of the method to re-determine the optimum receiving device after movement of the capsule endoscope 100 in the seventh embodiment. First, the control unit 220 commands the last optimum receiving device B207 and the receiving device B201 that is opposite to the receiving device B207 with respect to the Z axis to measure their received signal intensities (S31). According to the command, these receiving devices measure their received signal intensities to transmit the measurement results to the control unit 220.

The control unit 220 judges based on the measurement results whether the received signal intensity of the receiving device B207 is higher than that of the receiving device B201 by a predetermined value or more (S32). When the control unit 220 has judged that the received signal intensity of the receiving device B207 is higher than that of the receiving device B201 by a predetermined value or more (S32: YES), the capsule endoscope 100 is judged closer to the receiving device B207 than to the receiving device B201, and the process goes to S33. When the control unit 220 has not judged that the received signal intensity of the receiving device B207 is higher than that of the receiving device B201 by a predetermined value or more (S32: NO), a receiving device that is the closest to the capsule endoscope 100 is judged to be one of receiving devices other than the receiving device B207, and the process in the flowchart shown in FIG. 21 is terminated. Then, the process in the flowchart shown in FIG. 19 is executed again.

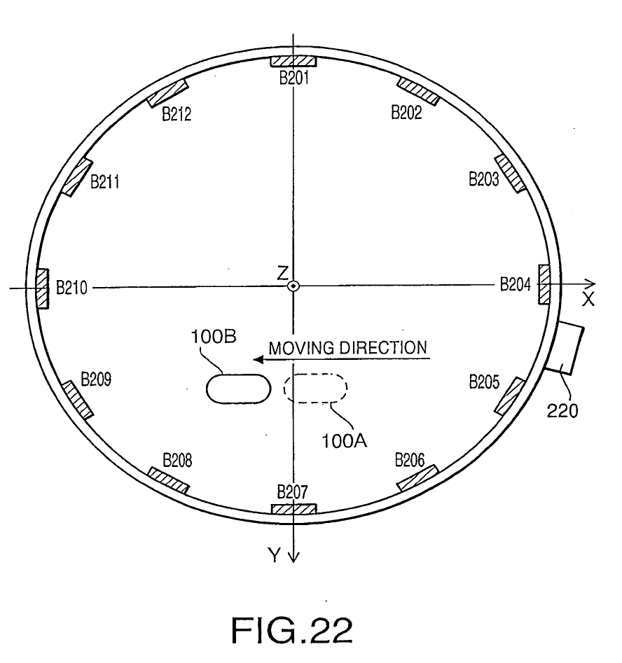

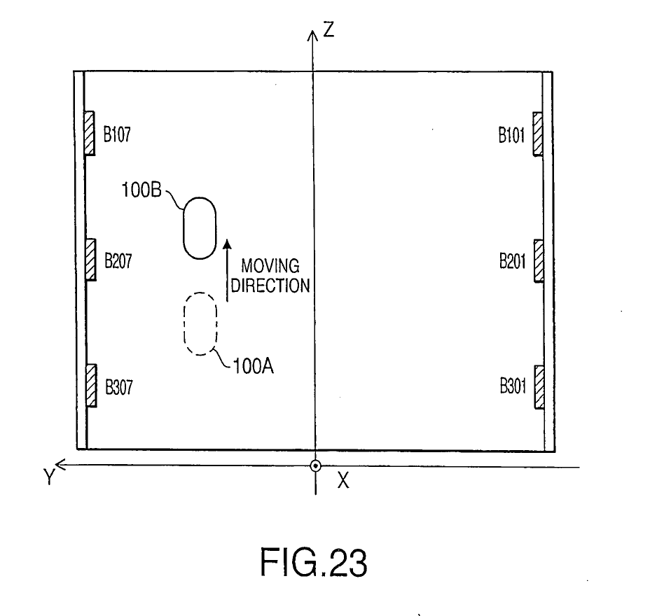

The steps of S33 and later in the flowchart shown in FIG. 21 will be described. It is assumed that the capsule endoscope 100 moves as shown in FIGS. 22 and 23. FIG. 22 indicates that the capsule endoscope 100 is moving from the fourth guardant to the third guardant along the X axis in the X-Y plane. FIG. 23 indicates that the capsule endoscope 100 is moving in a direction from the third row to the first row along the Z axis in the Y-Z plane.

In S32, it has already been clear that the capsule endoscope 100 is located in a neighboring region of the receiving device B207. Therefore, the control unit 220 commands the receiving device B207, the receiving devices B206 and B208 adjacent thereto in the second row, and the receiving devices B106, B107, B108, B306, B307, B308 that are at the same location as the receiving devices B206, B207, and B208 in the X-Y coordinates to measure their received signal intensities (S33). Each of the receiving devices measures the received signal intensity thereof according to such a command to transmit the measurement result to the control unit 220. The control unit 220 compares the received signal intensities with each other (S34) to determine the optimum receiving device (S35). As shown in FIGS. 22 and 23, the capsule endoscope 100B after movement is the closest to the receiving device B208. Accordingly, the receiving device B208 is defined as the optimum receiving device. Thereafter, the optimum transmission channel is determined (S36), and the process of the flowchart shown in FIG. 21 is terminated.

It is noted that any of the aforementioned first, second, and third methods is applicable to the processes of comparing the received signal intensities in S25 shown in FIG. 19 and S34 shown in FIG. 21. In addition, the re-determining operation is carried out under any of the above-mentioned first, second, and third starting conditions for the re-determining operation.

The present disclosure relates to the subject matter contained in Japanese Patent Application No. P2004-351474, filed on Dec. 3, 2004, which is expressly incorporated herein by reference in its entirely.

1. A method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method comprising:
first selecting a first plurality of receiving devices, of which received signal intensities are to be measured, among the plurality of communication devices;
first measuring the received signal intensities of the first plurality of receiving devices;
first comparing the received signal intensities of the first plurality of receiving devices;
second selecting a second plurality of receiving devices based on the results of the first comparing the received signal intensities;
second measuring the received signal intensities of the second plurality of receiving devices;
second comparing the received signal intensities of the second plurality of receiving devices; and
determining the optimum receiving device based on the results of the second comparing the received signal intensities.

2. The method to determine an optimum receiving device according to claim 1,
wherein the selected second plurality of receiving devices includes neighboring communication devices of a receiving device with the highest received signal intensity among the first plurality of receiving devices.

3. The method to determine an optimum receiving device according to claim 1,
wherein the second selecting the second plurality of receiving devices comprises:
calculating a ratio of a second highest received signal intensity to a highest received signal intensity among the received signal intensities of the first plurality of receiving devices; and
comparing the calculated ratio with a predetermined ratio,
wherein when the calculated ratio is the predetermined ratio or more, the second plurality of receiving devices includes a receiving device with the highest received signal intensity among the first plurality of receiving devices, neighboring communication devices of the receiving device with the highest received signal intensity, a receiving device with the second highest received signal intensity among the first plurality of receiving devices, and neighboring communication devices of the receiving device with the second highest received signal intensity, and
wherein when the calculated ratio is less than the predetermined ratio, the second plurality of receiving devices includes the receiving device with the highest received signal intensity among the first plurality of receiving devices, and neighboring communication devices of the receiving device with the highest received signal intensity.

4. The method to determine an optimum receiving device according to claim 1,
wherein, in the determining the optimum receiving device, a receiving device with the highest received signal intensity among the second plurality of receiving devices is defined as the optimum receiving device.

5. The method to determine an optimum receiving device according to claim 1, further comprising re-determining a different optimum receiving device when at least one predetermined condition is satisfied after the determining the optimum receiving device.

6. The method to determine an optimum receiving device according to claim 5,
wherein the at least one predetermined condition includes a condition that the received signal intensity of the optimum receiving device is less than a predetermined intensity.

7. The method to determine an optimum receiving device according to claim 5,
wherein the at least one predetermined condition includes a condition that a predetermined time period has passed.

8. The method to determine an optimum receiving device according to claim 5,
wherein the at least one predetermined condition includes a condition that the absolute time rate of change of the received signal intensity of the optimum receiving device is a predetermined value or more.

9. The method to determine an optimum receiving device according to claim 5,
wherein the re-determining a different optimum receiving device comprises:
third selecting a third plurality of receiving devices, of which received signal intensities are to be measured, among the plurality of communication devices;
third measuring the received signal intensities of the third plurality of receiving devices;
third comparing the received signal intensities of the third plurality of receiving devices; and
re-determining the different optimum receiving device based on the results of the third comparing the received signal intensities.

10. The method to determine an optimum receiving device according to claim 9,
wherein the selected third plurality of receiving devices includes neighboring communication devices of the optimum receiving device.

11. The method to determine an optimum receiving device according to claim 9,
wherein the third plurality of receiving devices is selected based on a moving direction, of the external device, presumed from the history of past optimum receiving devices.

12. A method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method comprising:
measuring received signal intensities of all the plurality of communication devices;
comparing the received signal intensities of all the plurality of communication devices with each other; and
determining the optimum receiving device based on the results of the comparing the received signal intensities.

13. The method to determine an optimum receiving device according to claim 12,
wherein, in the determining the optimum receiving device, a communication device with the highest received signal intensity is defined as the optimum receiving device.

14. A method to determine an optimum receiving device, which receives a signal outputted from a separate device through wireless communication, among a plurality of communication devices two-dimensionally arranged on a two dimensional diffusive signal-transmission board, the plurality of communication devices being configured to communicate with each other using a two dimensional diffusive signal-transmission technology, the method comprising:
measuring received signal intensities of all the plurality of communication devices;
comparing the received signal intensities of all the plurality of communication devices with a predetermined intensity;
specifying a region in which communication devices with received signal intensities of the predetermined intensity or more are included; and
determining the optimum receiving device among the communication devices in the specified region.

15. The method to determine an optimum receiving device according to claim 14,
wherein, in the determining the optimum receiving device, a communication device located substantially at the center of the region is defined as the optimum receiving device.

16. The method to determine an optimum receiving device according to claim 14,
wherein, in the determining the optimum receiving device, a communication device located the closest to a control unit, which is configured to implement the method to determine the optimum receiving device, provided at the two dimensional diffusive signal-transmission board, is defined as the optimum receiving device.

17. A signal processing apparatus that receives a signal output from a separate device through wireless communications and determines an optimum receiving device, the apparatus comprising:
a two dimensional diffusive signal-transmission board;
a plurality of communication devices, two-dimensionally arranged in the two dimensional diffusive signal-transmission board, which are configured to communicate with each other using a two dimensional diffusive signal-transmission technology; and
a controller that selects a first plurality of receiving devices, of which received signal intensities are to be measured, from among the plurality of communication devices,
that measures the received signal intensities of the first plurality of receiving devices,
that compares the received signal intensities of the first plurality of receiving devices,
that selects a second plurality of receiving devices based on results of the first comparing comparison of the received signal intensities,
that measures the received signal intensities of the second plurality of receiving devices,
that compares the received signal intensities of the second plurality of receiving devices and that determining determines the optimum receiving device based on the results of the
comparison of the received signal intensities.

18. The signal processing apparatus according to claim 17,
wherein the selected second plurality of receiving devices includes neighboring communication devices of a receiving device with a highest received signal intensity among the first plurality of receiving devices.

19. The signal processing apparatus according to claim 17,
wherein the controller selects the second plurality of receiving devices by calculating a ratio of a second highest received signal intensity to a highest received signal intensity among the received signal intensities of the first plurality of receiving devices; and
comparing the calculated ratio with a predetermined ratio,
wherein when the calculated ratio is at least the predetermined ratio or more, the second plurality of receiving devices includes a receiving device with the highest received signal intensity among the first plurality of receiving devices, neighboring communication devices of the receiving device with the highest received signal intensity, a receiving device with the second highest received signal intensity among the first plurality of receiving devices, and neighboring communication devices of the receiving device with the second highest received signal intensity, and
wherein when the calculated ratio is less than the predetermined ratio, the second plurality of receiving devices includes the receiving device with the highest received signal intensity among the first plurality of receiving devices, and neighboring communication devices of the receiving device with the highest received signal intensity.

20. The signal processing apparatus according to claim 17,
wherein, the controller determines the optimum receiving device to be a receiving device with a highest received signal intensity among the second plurality of receiving devices.
